(19) United States
(12) Patent Application Publication
(10) Pub. No.: US 2013/0169559 A1
(43) Pub. Date: Jul. 4, 2013

(54) ELECTRONIC DEVICE AND TOUCH SENSING METHOD OF THE ELECTRONIC DEVICE

(71) Applicant: YU-CHIH PENG, Shindian (TW)

(72) Inventor: YU-CHIH PENG, Shindian (TW)

(73) Assignee: FIH (HONG KONG) LIMITED, Kowloon (HK)

(21) Appl. No.: 13/620,321

(22) Filed: Sep. 14, 2012

(30) Foreign Application Priority Data
Dec. 28, 2011 (TW) 100149078

(51) Int. Cl. G06F 3/041

(52) U.S. Cl. 345/173; 178/18.03

(57) ABSTRACT

In a touch sensing method of an electronic device, the electronic device includes a touch panel, a signal multiplexer and a signal driver. The method detects one or more sensing signals transmitted from the signal multiplexer when the touch panel is touched, and determines whether the touch operation is a point touch or a coverage touch according to the touch points. The method generates a single point operation command when the point touch is a single point touch, generates a multi-point operation command when the point touch is a multi-point touch, generates a single finger operation command when the coverage touch is a single coverage touch, or generates a multi-finger operation command when the coverage touch is a multi-coverage touch. The method generates a driving signal corresponding to each of the operation commands, and sends the driving signal to the signal driver in response to the touch operation.

### BACKGROUND

1. Technical Field

Embodiments of the present disclosure relate to touch sensing systems and methods, and more particularly to an electronic device and a touch sensing method of the electronic device.

2. Description of Related Art

Handheld devices including a touch panel are widely used, and various input methods to operate the electronic devices are utilized, such as touch operations on the touch panel. Single-point touch operations such as contacting, moving, and leaving only one touch point on the touch panel can be sensed from the touch screen. Referring to FIG. 1, a second touch point P1 can be sensed when a touch panel 1 is touched by a finger, and a second touch point P2 can also be sensed when the finger touches the touch panel 1 for a second time. The handheld device performs a first function in response to the first touch point P1, and performs a second function in response to the second touch point P2.

However, a multi-point touch operation such as contacting, moving and leaving of a series of touch points on the touch panel cannot be sensed from the touch panel, and therefore the handheld device does not synchronously perform functions in response to the multi-point touch. Therefore, there is a need to provide an electronic device and a touch sensing method of the electronic device to overcome the above mentioned limitations.

### BRIEF DESCRIPTION OF THE DRAWINGS

FIG. 1 is a schematic diagram illustrating one example of a single-point touch on the touch screen.

FIG. 2 is a block diagram of one embodiment of an electronic device including a touch panel.

FIG. 3 is a block diagram of one embodiment of a control unit included in the electronic of FIG. 2.

FIG. 4 is a flowchart of one embodiment of a touch sensing method of the electronic device of FIG. 2.

FIG. 5 is a schematic diagram illustrating one example of a single coverage touch on the touch panel using one hand.

FIG. 6 a schematic diagram illustrating one example of a multi-coverage touch on the touch panel using two fingers.

FIG. 7 is a schematic diagram illustrating one example of a multi-point touch on the touch panel using one finger.

FIG. 8 is a schematic diagram illustrating one example of a touch operation of a 3D game displayed on the touch panel.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In the present disclosure, the word “module,” as used herein, refers to logic embodied in hardware or firmware, or to a collection of software instructions, written in a programming language. In one embodiment, the programming language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage system. Some non-limiting examples of a non-transitory computer-readable medium include CDs, DVDs, flash memory, and hard disk drives.

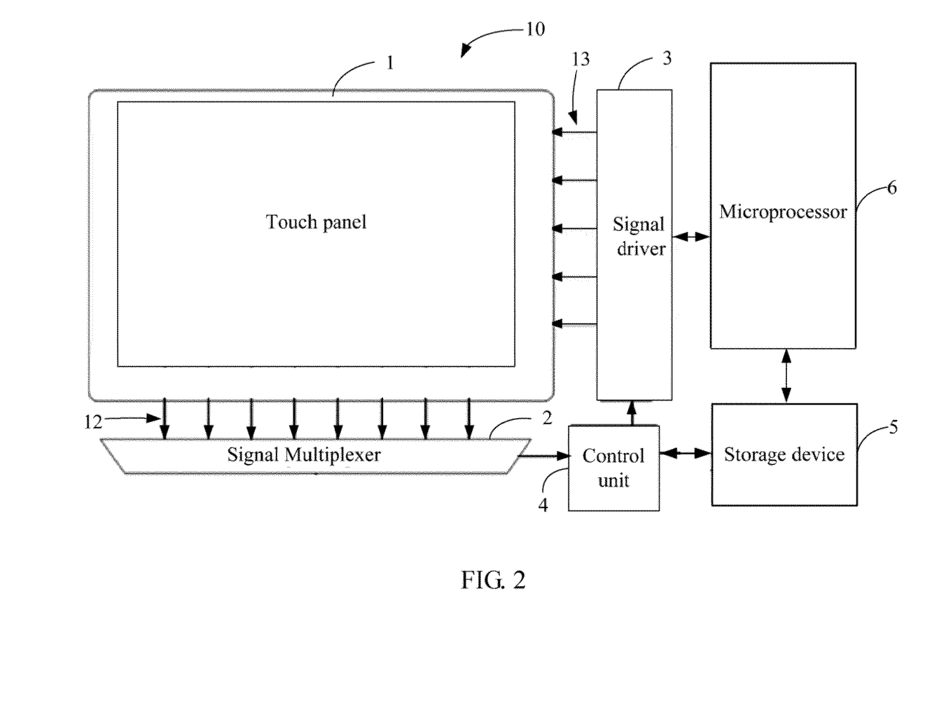

FIG. 2 is a block diagram of one embodiment of an electronic device 10 including a touch panel 1. In the embodiment, the electronic device 10 further includes, but is not limited to, a signal multiplexer 2, a signal driver 3, a control unit 4, a storage system 5 and at least one microprocessor 6. The electronic device 10 may be a mobile phone, an electronic book, a tablet computer, a personal digital assistant (PDA) device, or any other handheld device. The touch panel 1 connects to the signal multiplexer 2 through one or more signal sensing lines 12, and also connects to the signal driver 3 through one or more signal driving lines 13. The control unit 4 may include a plurality of functional modules that are stored in the storage system 5 and executed by the at least one microprocessor 6. FIG. 2 is only one example of the electronic device 10, other examples may include more or fewer components than those shown in the embodiment, or have a different configuration of the various components.

In the embodiment, the touch panel 1 is a projected capacitive touch panel, which generates one or more sensing signals when a finger touches or slides from a first sensing area to a second sensing area of the touch panel 1. The signal multiplexer 2 receives the sensing signals from the touch panel 1 through the one or more signal sensing lines 12, and sends the sensing signals to the control unit 4. The signal driver 3 receives the sensing signals from the control unit 4, generates one or more driving signals according to the sensing signals, and sends the driving signals to the touch panel 1 through the one or more signal driving lines 13, in response to the touch operation.

In one embodiment, the storage system 5 may be an internal storage system, such as a random access memory (RAM) for temporary storage of information, and/or a read only memory (ROM) for permanent storage of information. In some embodiments, the storage system 5 may also be an external storage system, such as an external hard disk, a storage card, or a data storage medium.

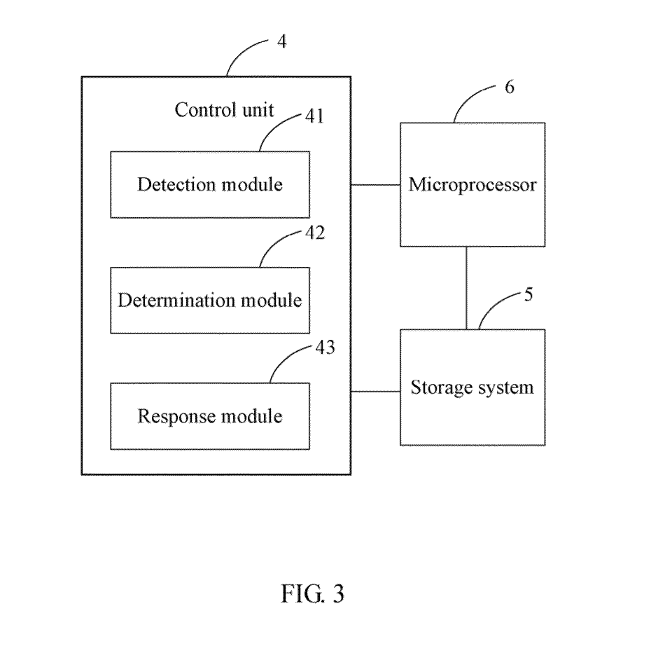

FIG. 3 is a block diagram of one embodiment of the control unit 4 included in the electronic device 10 of FIG. 2. In the embodiment, the control unit 4 includes a detection module 41, a determination module 42, and a response module 43. The modules 41-43 may comprise computerized instructions in the form of one or more programs that are stored in the storage system 5 and executed by the at least one microprocessor 6. Detailed descriptions of each module will be given in the following paragraphs.

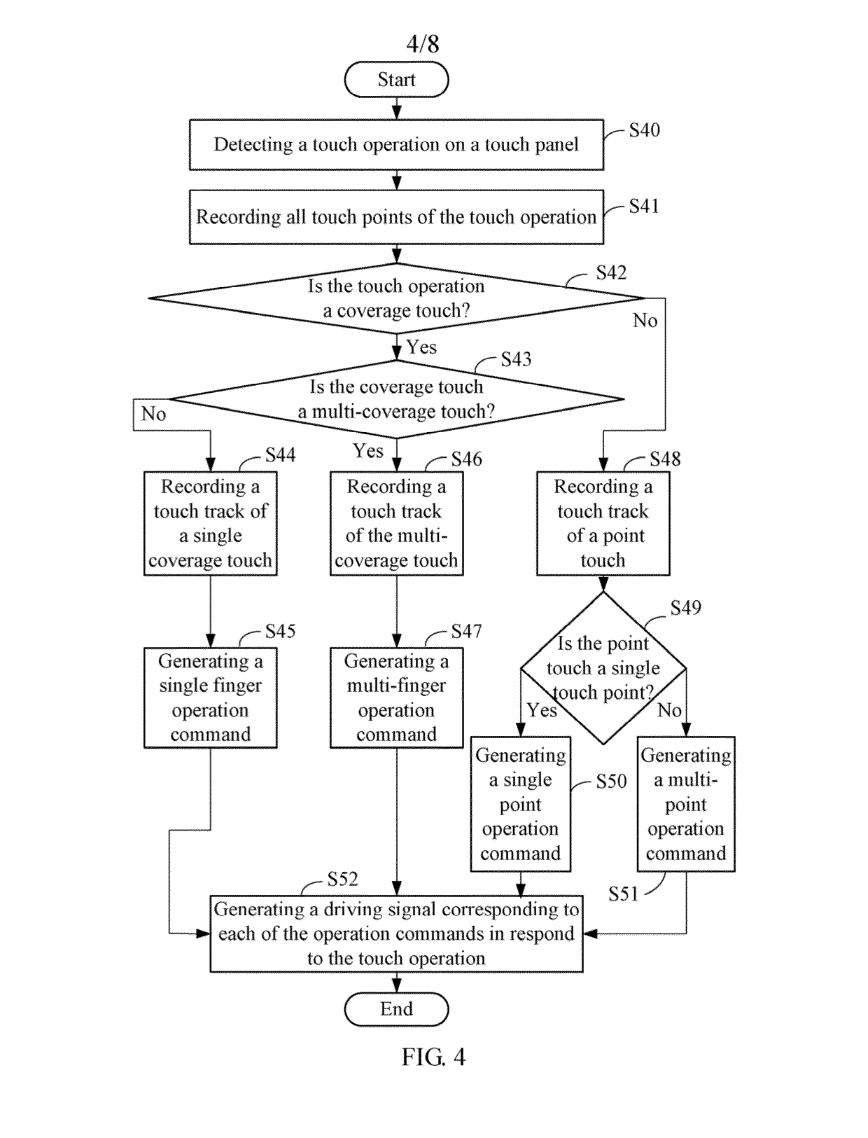

FIG. 4 is a flowchart of one embodiment of a touch sensing method of the electronic device 10 of FIG. 2. Depending on the embodiment, additional steps may be added, others removed, and the ordering of the steps may be changed.

In step S40, the detection module 41 detects one or more sensing signals transmitted from the signal multiplexer 2 when the touch panel 1 is touched by one or more fingers, and determines a touch operation on the touch panel 1 according to the sensing signals. The touch panel 1 generates one or more sensing signals when the one or more fingers touches the touch panel 1, and sends the sensing signals to the signal multiplexer 2 through the signal sensing lines 12. In the embodiment, the touch operation may be a single point touch, a multi-point touch, a single coverage touch, or a multi-coverage touch as will be explained below.

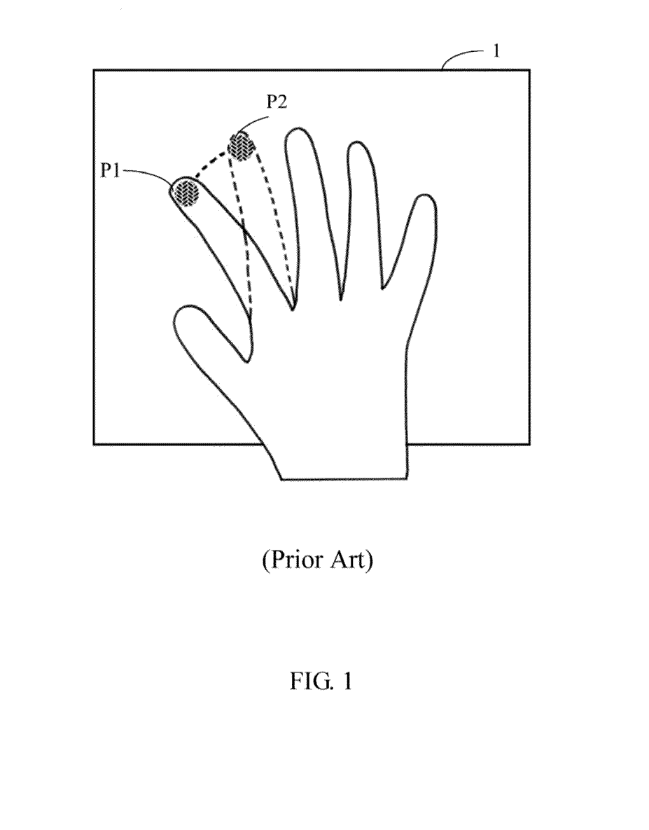

The single point touch is defined as a touch on a single point on the touch panel 1. The multi-point touch is defined as simultaneous touches on a plurality of points on the touch panel 1. Referring to FIG. 1, the first touch point P1 can be sensed by the touch panel 1 when the touch panel 1 is touched by a finger, and the second touch point P2 can also be sensed by the touch panel 1 when the finger touches the touch panel 1.

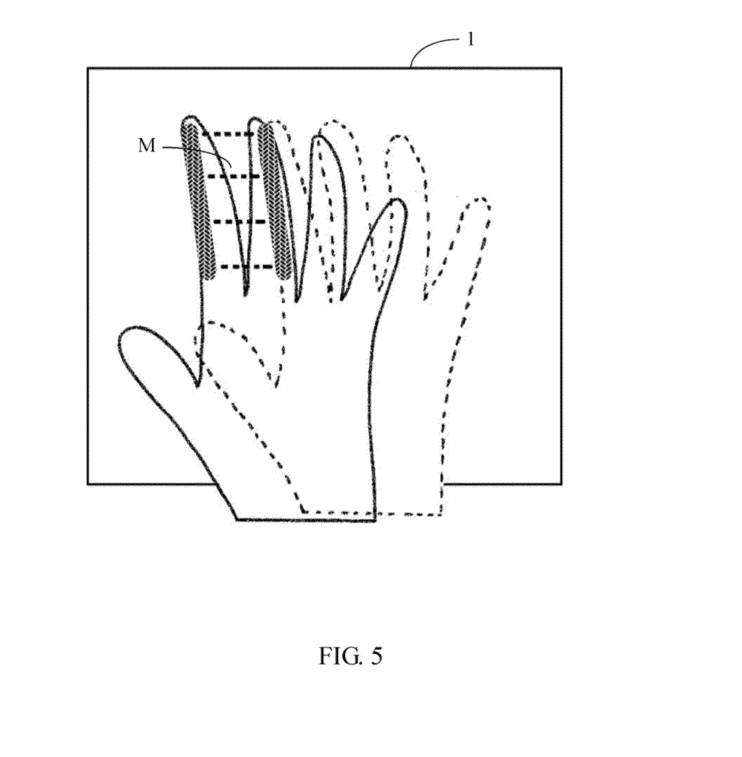

The single coverage touch is defined as a touch operation over a single unbroken area of the touch panel 1. In one embodiment, the unbroken area can be a large or small area of the touch panel 1. Referring to FIG. 5, which is a schematic diagram illustrating one example of the single coverage touch on the touch panel 1 using one finger of the hand. The single coverage M is formed when the user touches the touch panel 1 using one finger.

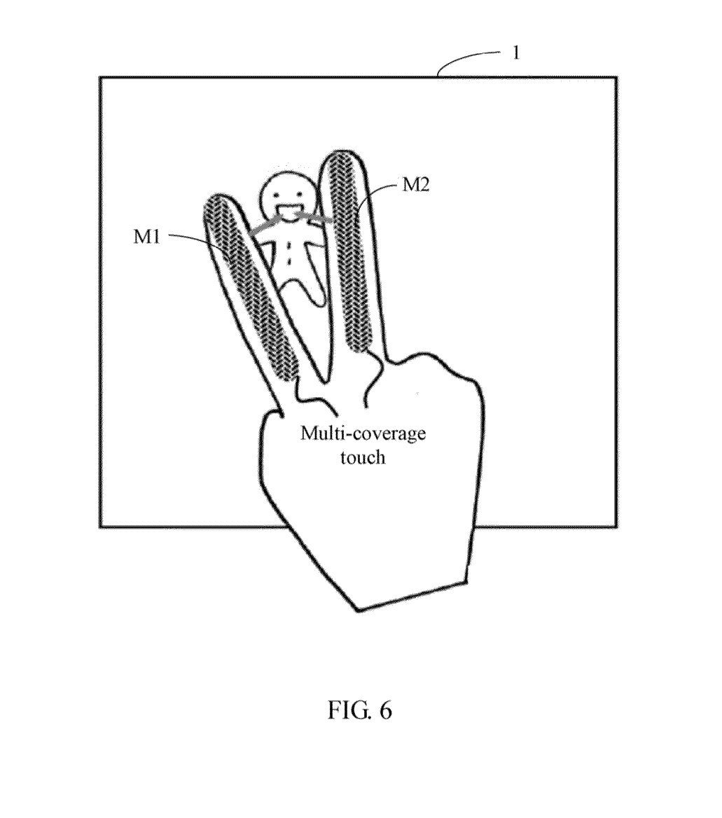

The multi-coverage touch is defined as a touch operation of more than one simultaneous single coverage touches on the touch panel 1. Referring to FIG. 6, which is a schematic diagram illustrating one example of the multi-coverage touch on the touch panel 1 using two fingers. The touch coverage M1 and the touch coverage M2 are formed when the two independent single unbroken areas of the touch panel 1 are touched by two fingers.

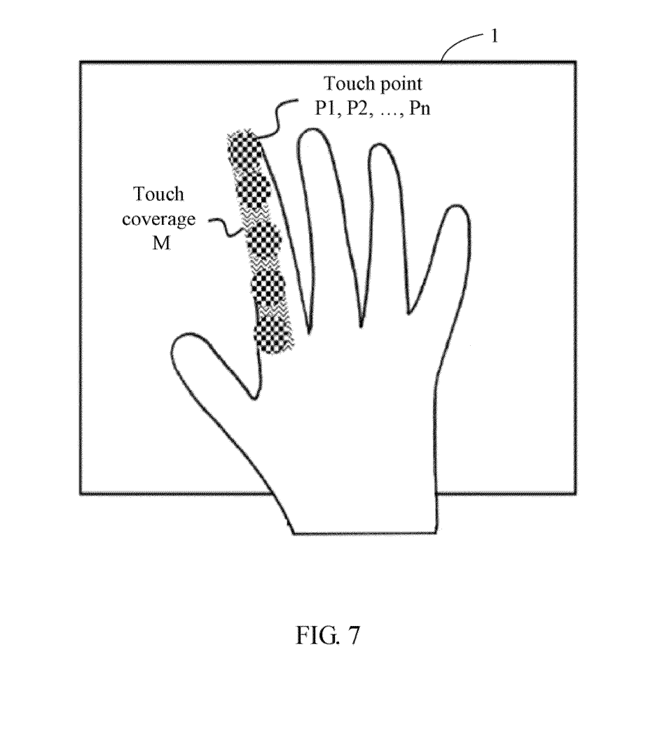

In step S41, the detection module 41 records all touch points of the touch operation. In the embodiment, when the finger touches on the touch panel 1, the detection module 41 records all touch points of the touch panel 1, such as the touch points P1, P2, . . . , and Pn, as shown in FIG. 7.

In step S42, the determination module 42 determines whether the touch operation is a point touch or a coverage touch according to the touch points. If the touch operation is a coverage touch, step S43 is implemented. If the touch operation is a point touch, step S48 is implemented. In one embodiment, the determination module 42 performs a regression analysis of any two adjacent points of the touch points to determine whether the touch operation is a point touch or a coverage touch. If the two adjacent points overlap to approach to one point, the determination module 42 determines that the touch operation is a point touch. If the two adjacent points with a third point of the touch points form a coverage plane on the touch panel 1, the determination module 42 determines that the touch operation is a coverage touch. Referring to FIG. 7, which is a schematic diagram illustrating one example of a coverage touch on the touch panel 1 using one finger. When the user slides from the first sensing area to the second sensing area of the touch panel 1 using one finger, the coverage touch M is formed based on the touch points P1, P2, . . . , and Pn.

In step S43, the determination module 42 determines whether the coverage touch is a single coverage touch or a multi-coverage touch according to the sensing signal transmitted from signal multiplexer 2. In the embodiment, if the touch panel 1 sends only one sensing signal transmitted from the signal multiplexer 2, the determination module 42 determines that the coverage touch is a single coverage touch, and step S44 is implemented. If the touch panel 1 sends more than one sensing signals transmitted from the signal multiplexer 2, the determination module 42 determines that the coverage touch is a multi-coverage touch, and step S46 is implemented.

In step S44, the response module 43 records a touch track of the single coverage touch, such as the single coverage M as shown in FIG. 5. In step S45, the response module 43 generates a single finger operation command according to the touch track of the single coverage touch.

In step S46, the response module 43 records a touch track of the multi-coverage touch, such as the multi-coverage areas M1 and M2 as shown in FIG. 6. In step S47, the response module 43 generates a multi-finger operation command according to the touch track of the multi-coverage touch.

In step S48, the response module 43 records a touch track of the point touch operation. In step S49, the response module 43 determines whether the point touch is a single point touch or a multi-point touch according to the sensing signals transmitted from the signal multiplexer 2. If the point touch is the single point touch, step S50 is implemented. If the point touch is the multi-point touch, step S51 is implemented.

In step S50, the response module 43 generates a single point operation command according to the single touch point. In step S51, the response module 43 generates a multi-point operation command according to the multi-touch points.

In step S52, the response module 43 generates a driving signal corresponding to the operation command, and sends the driving signal to the signal driver 3 in response to the touch operation on the touch panel 1. For example, if the user touches or slides from the first sensing area to the second sensing area of the touch panel using two fingers, the response module 43 generates a multi-finger operation command to perform a multi-touch function of the electronic device 10.

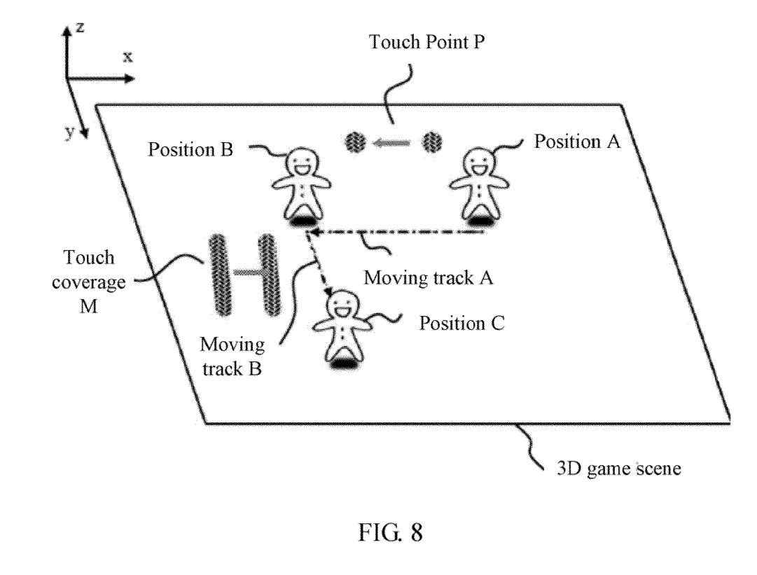

In one embodiment, assuming that the user is playing a 3D game of the electronic device 10, the user may operate a 3D scene of the 3D game displayed on the touch panel 1 using one or more fingers. In one example with respect FIG. 8, which is a schematic diagram illustrating one example of a touch operation of a 3D game displayed on the touch panel 1. In the 3D scene of the 3D game, the user can drag a person from one position “A” to another position “B” using one finger, and drags the person from one position “A” to another position “C” using two or three fingers, the direction of drag depending on the type of touch employed by the user.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
a touch panel, a signal multiplexer, and a signal driver; and
a control unit comprising one or more programs stored in a storage system and executed by at least one microprocessor, the one or more programs comprising:
a detection module that detects one or more sensing signals transmitted from the signal multiplexer when the touch panel is touched by one or more fingers, determines a touch operation on the touch panel according to the sensing signals, and records all touch points of the touch operation;
a determination module that determines whether the touch operation is a point touch or a coverage touch according to the touch points, determines whether the point touch is a single point touch or a multi-point touch when the touch operation is the point touch, and determines whether the coverage touch is a single coverage touch or a multi-coverage touch when the touch operation is the coverage touch; and
a response module that generates a single point operation command when the point touch is a single point touch, generates a multi-point operation command when the point touch is a multi-point touch, generates a single finger operation command when the coverage touch is a single coverage touch, generates a multi-finger operation command when the coverage touch is a multi-coverage touch, generates a driving signal corresponding to the operation command, and sends the driving signal to the signal driver in response to the touch operation on the touch panel.

2. The electronic device according to claim 1, wherein the touch panel is a projected capacitive touch panel that generates the one or more sensing signals when the fingers touch or slide from a first sensing area to a second sensing area of the touch panel.

3. The electronic device according to claim 1, wherein the touch panel connects to the signal multiplexer through one or more signal sensing lines, and connects to the signal driver through one or more signal driving lines.

4. The electronic device according to claim 3, wherein the signal multiplexer receives the sensing signals from the touch panel through the one or more signal sensing lines.

5. The electronic device according to claim 3, wherein the signal driver sends the driving signal to the touch panel in response to the touch operation through the one or more signal driving lines.

6. The electronic device according to claim 1, wherein the determination module determines whether the touch operation is a point touch or a coverage touch by performing steps of:
executing a regression analysis of any two adjacent points of the touch points; and
determining that the touch operation is a point touch if the two adjacent points is overlap to approach to one point; or
determining that the touch operation is a coverage touch if the two adjacent points with a third point of the touch points form a coverage plane on the touch panel.

7. A touch sensing method of an electronic device, the electronic device comprising a touch panel, a signal multiplexer and a signal driver, the method comprising:
detecting one or more sensing signals transmitted from the signal multiplexer when the touch panel is touched by one or more fingers;
determining a touch operation on the touch panel according to the sensing signals, and recording all touch points of the touch operation;
determining whether the touch operation is a point touch or a coverage touch according to the touch points;
if the touch operation is a point touch, generating a single point operation command when the point touch is a single point touch, or generating a multi-point operation command when the point touch is a multi-point touch;
if the touch operation is a coverage touch, generating a single finger operation command when the coverage touch is a single coverage touch, or generating a multi-finger operation command when the coverage touch is a multi-coverage touch; and
generating a driving signal corresponding to the operation command, and sending the driving signal to the signal driver in response to the touch operation on the touch panel.

8. The method according to claim 7, wherein the touch panel is a projected capacitive touch panel that generates the one or more sensing signals when the fingers touch or slide from a first sensing area to a second sensing area of the touch panel.

9. The method according to claim 7, wherein the touch panel connects to the signal multiplexer through one or more signal sensing lines, and connects to the signal driver through one or more signal driving lines.

10. The method according to claim 9, wherein the signal multiplexer receives the sensing signals from the touch panel through the one or more signal sensing lines.

11. The method according to claim 9, wherein the signal driver sends the driving signal to the touch panel in response to the touch operation through the one or more signal driving lines.

12. The method according to claim 7, wherein the step of determining whether the touch operation is a point touch or a coverage touch comprises steps of:
executing a regression analysis of any two adjacent points of the touch points; and
determining that the touch operation is a point touch if the two adjacent points is overlap to approach to one point; or
determining that the touch operation is a coverage touch if the two adjacent points with a third point of the touch points form a coverage plane on the touch panel.

13. A non-transitory storage medium having stored thereon instructions that, when executed by at least one microprocessor of an electronic device, causes the electronic device to perform a touch sensing method, the electronic device comprising a touch panel, a signal multiplexer and a signal driver, the method comprising:
detecting one or more sensing signals transmitted from the signal multiplexer when the touch panel is touched by one or more fingers;
determining a touch operation on the touch panel according to the sensing signals, and recording all touch points of the touch operation;
determining whether the touch operation is a point touch or a coverage touch according to the touch points;
if the touch operation is a point touch, generating a single point operation command when the point touch is a single point touch, or generating a multi-point operation command when the point touch is a multi-point touch;
if the touch operation is a coverage touch, generating a single finger operation command when the coverage touch is a single coverage touch, or generating a multi-finger operation command when the coverage touch is a multi-coverage touch; and
generating a driving signal corresponding to the operation command, and sending the driving signal to the signal driver in response to the touch operation on the touch panel.

14. The storage medium according to claim 13, wherein the wherein the touch panel is a projected capacitive touch panel that generates the one or more sensing signals when the fingers touch or slide from a first sensing area to a second sensing area of the touch panel.

15. The storage medium according to claim 13, wherein the touch panel connects to the signal multiplexer through one or more signal sensing lines, and connects to the signal driver through one or more signal driving lines.

16. The storage medium according to claim 15, wherein the signal multiplexer receives the sensing signals from the touch panel through the one or more signal sensing lines.

17. The storage medium according to claim 15, wherein the signal driver sends the driving signal to the touch panel in response to the touch operation through the one or more signal driving lines.

18. The storage medium according to claim 13, wherein the step of determining whether the touch operation is a point touch or a coverage touch comprises steps of:
executing a regression analysis of any two adjacent points of the touch points; and
determining that the touch operation is a point touch if the two adjacent points is overlap to approach to one point; or
determining that the touch operation is a coverage touch if the two adjacent points with a third point of the touch points form a coverage plane on the touch panel.
